(19) United States
(12) Patent Application Publication
(10) Pub. No.: US 2019/0007850 A1
(43) Pub. Date: Jan. 3, 2019

(54) SYSTEMS AND METHODS FOR CONTROLLING RECEIVE DIVERSITY FOR WIRELESS PERSONAL AREA NETWORK COMMUNICATION

(71) Applicant: QUALCOMM Incorporated, San Diego, CA (US)

(72) Inventors: Paul DenBoer, Escondido, CA (US); Anssi Haverinen, San Diego, CA (US); Le Luong, San Diego, CA (US); Yoshiro Fukuoka, Solana Beach, CA (US); Huibert DenBoer, Escondido, CA (US); Joel Linsky, San Diego, CA (US); Thomas Cargill, San Diego, CA (US)

(21) Appl. No.: 15/636,386

(22) Filed: Jun. 28, 2017

(51) Int. Cl. H04W 24/08; H04W 4/00; H04B 7/08; H04W 52/02

(52) U.S. Cl. CPC H04W 24/08; H04W 52/0229; H04B 7/0814; H04W 4/008

(57) ABSTRACT

A method performed by a wireless communication device is described. The method includes determining at least one packet type for subsequent wireless personal area network (WPAN) communication. The method also includes determining at least one receive diversity setting based on the at least one packet type. The method further includes receiving at least one packet based on the at least one receive diversity setting.

### TECHNICAL FIELD

The present disclosure relates generally to wireless communications. More specifically, the present disclosure relates to systems and methods for controlling receive diversity for wireless personal area network (WPAN) communication.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Many electronic devices may make use of wireless communication technology. For example, a wireless communication device may communicate with one or more remote devices using wireless technology.

In some cases, wireless communications may waste power and/or may offer poor performance. For example, power may be unnecessarily spent to communicate and/or some wireless communications may be degraded. As can be observed from this discussion, improvements in wireless communication may be beneficial.

### SUMMARY

A method performed by a wireless communication device is described. The method includes determining at least one packet type for subsequent wireless personal area network (WPAN) communication. The method also includes determining at least one receive diversity setting based on the at least one packet type. The method further includes receiving at least one packet based on the at least one receive diversity setting.

The method may include obtaining a performance target. Determining the at least one receive diversity setting may be further based on the performance target.

Determining the at least one receive diversity setting may include determining a first diversity setting for an acquisition portion of the at least one packet. Determining the at least one receive diversity setting may also include determining a different second diversity setting for a demodulation portion of the at least one packet. The first diversity setting may be enabled diversity and the second diversity setting may be disabled diversity, or the first diversity setting may be disabled diversity and the second diversity setting may be enabled diversity. Receiving at least one packet based on the at least one receive diversity setting may include performing intra-packet diversity switching.

Determining the at least one receive diversity setting may include determining a first diversity setting for a first packet type. The first packet type may be used for setup of a connection. Determining the at least one receive diversity setting may also include determining a different second diversity setting for a second packet type. The second packet type may be used for the connection. Receiving at least one packet based on the at least one receive diversity setting may include performing inter-packet diversity switching.

A first packet scheme may include a first packet type for setup and a second packet type for connection. A second packet scheme may include a third packet type for setup and a fourth packet type for connection. The method may include using the first packet type of the first packet scheme for setup and using the fourth packet type of the second packet scheme for connection.

The method may include determining a signal quality measure based on the at least one packet. The method may also include determining whether to adjust the at least one receive diversity setting based on the signal quality measure. Determining whether to adjust the at least one receive diversity setting based on the signal quality measure may include determining to enable diversity for a connection in a case that the signal quality measure is below a quality threshold.

A wireless communication device is also described. The wireless communication device includes a memory and a processor coupled to the memory. The processor is configured to determine at least one packet type for subsequent wireless personal area network (WPAN) communication. The processor is also configured to determine at least one receive diversity setting based on the at least one packet type. The wireless communication device also includes a receiver coupled to the processor. The receiver is configured to receive at least one packet based on the at least one receive diversity setting.

A non-transitory tangible computer-readable medium storing computer executable code is also described. The computer-readable medium includes code for causing a wireless communication device to determine at least one packet type for subsequent wireless personal area network (WPAN) communication. The computer-readable medium also includes code for causing the wireless communication device to determine at least one receive diversity setting based on the at least one packet type. The computer-readable medium further includes code for causing the wireless communication device to receive at least one packet based on the at least one receive diversity setting.

An apparatus is also described. The apparatus includes means for determining at least one packet type for subsequent wireless personal area network (WPAN) communication. The apparatus also includes means for determining at least one receive diversity setting based on the at least one packet type. The apparatus further includes means for receiving at least one packet based on the at least one receive diversity setting.

### BRIEF DESCRIPTION OF THE DRAWINGS

FIG. 1 is a block diagram illustrating one configuration of a wireless communication system in which systems and methods for controlling receive diversity for wireless personal area network (WPAN) communication may be implemented;

FIG. 2 is a flow diagram illustrating a method for controlling receive diversity for WPAN communication;

FIG. 3 illustrates an example of inter-packet diversity switching;

FIG. 4 illustrates another example of inter-packet diversity switching;

FIG. 5 illustrates an example of intra-packet diversity switching;

FIG. 6 illustrates yet another example of inter-packet diversity switching;

FIG. 7 illustrates yet another example of inter-packet diversity switching;

FIG. 8 is a flow diagram illustrating an example of a more specific method for controlling receive diversity for WPAN communication;

FIG. 9 is a flow diagram illustrating a more specific configuration of a method for controlling receive diversity for WPAN communication;

FIG. 10 is a flow diagram illustrating another more specific configuration of a method for controlling receive diversity for WPAN communication; and

FIG. 11 illustrates certain components that may be included within a wireless communication device.

### DETAILED DESCRIPTION

The detailed description set forth below in connection with the appended drawings is intended as a description of exemplary implementations of the disclosure and is not intended to represent the only implementations in which the disclosure may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations of the disclosure. In some instances, some devices are shown in block diagram form.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Some configurations of the systems and methods disclosed herein may relate to controlling receive diversity for wireless personal area network (WPAN) communication. For example, some implementations of the systems and methods disclosed herein may relate to WPAN connection setup (e.g., connection setup optimization) with receive diversity.

WPAN devices that require long range communication may use receive diversity techniques to increase sensitivity. For example, Maximum Ratio Combiner (MRC) with two or more radio receivers and antennas is one diversity technique that may be utilized to increase receiver sensitivity.

Different packet types used for connection setup and connection may have different levels of robustness. For example, a receiver for Bluetooth (BT) classic 1 megabits per second (Mbps) packets used for connection setup may be more sensitive than 2 Mbps and 3 Mbps packets used for an enhanced data rate connection. This may lead to a shorter operating range for the connection than for connection setup. Alternatively, using BT Long Range or BT Low Energy 1 Mbps packet types for connection setup and then switching to higher rate packets during the connection may lead to a shorter operating range for the connection. In another example, advanced packet types using forward error correction and/or advanced modulation types may provide more sensitivity than standard BT classic, BT Long Range, BT Low Energy, and/or Institute of Electrical and Electronics Engineers (IEEE) 802.15.4 (“15.4”) connection setup packets, etc. Due to the lower sensitivity of some packet types, a device may be unable to connect at a range where maintaining connection would still be possible with other packet types that exhibit higher sensitivity.

An example of an algorithm in accordance with some configurations of the systems and methods disclosed herein may operate in accordance with the following. The algorithm may obtain one or more of the following inputs: a receiver sensitivity for demodulation for different packet types with and without diversity, a receiver sensitivity for acquisition for different packet types with and without diversity, and/or whether diversity is enabled for connection. An output of the algorithm may allow a diversity receiver to enable/disable dynamically.

Examples of cases in which some configurations of the systems and methods disclosed herein may be applied are given as follows. In a first case, connection setup packets are more robust than connection packets. In this example, diversity may be disabled during scans and connection setup. Diversity may be enabled during connection to balance range performance. In a second case, connection setup packets are less robust than connection packets. In this example, diversity may be enabled during scans and connection setup. Diversity may be disabled during connection to balance range performance. Diversity may be enabled during connection, if a link quality drop requires it. In a third case, packet acquisition sensitivity of the modem may be lower than that of demodulation. In this example, diversity may be enabled during acquisition only to save power during demodulation, and to balance acquisition and demodulation performance.

Some configurations of the systems and methods disclosed herein may allow connection setup with standard packet types and connection with proprietary or standard advanced packet types without compromising range and power consumption of either. Another benefit may include allowing mixing connection setup and connection procedures between different standards without performance compromises. For example, BT Long Range may be used for connection setup, and BT Low Energy may be used for connection.

It should be noted that switching between enabled receive diversity (e.g., multiple antennas) and disabled receive diversity (e.g., a single antenna) may be performed between packets (e.g., inter-packet switching) and/or between packet portions (e.g., intra-packet switching). For example, a first receive diversity setting may be utilized for connection setup packets and may be switched to a second receive diversity setting for connection packets. In another example, a first receive diversity setting may be utilized for a first packet portion (e.g., packet acquisition, a packet preamble, etc.) and may be switched to a second receive diversity setting for a second packet portion (e.g., packet demodulation, a packet payload, etc.).

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

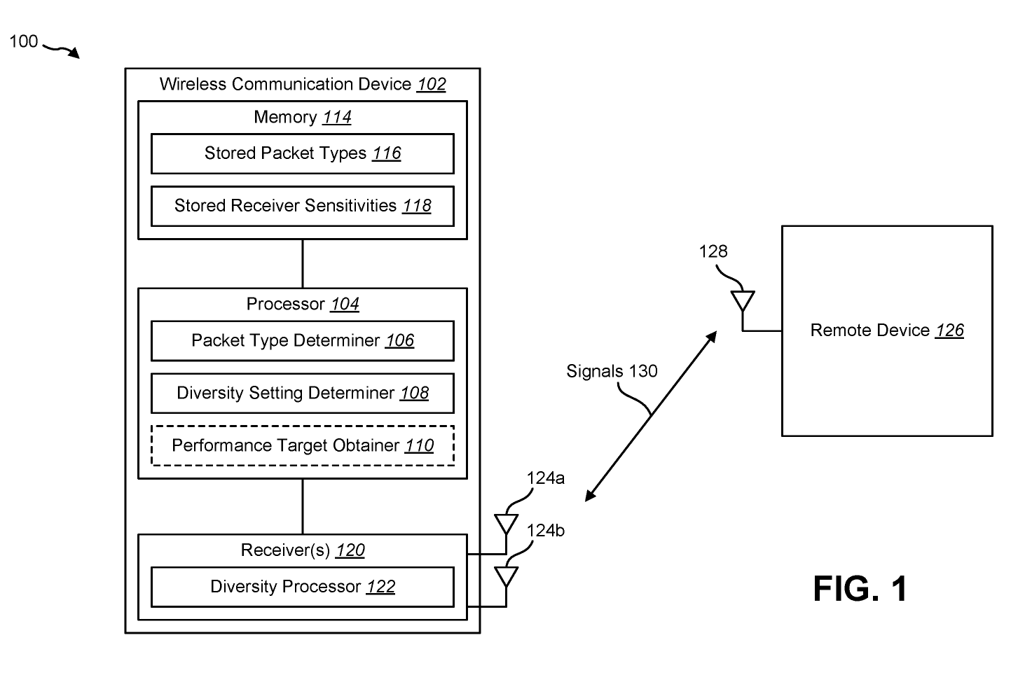

FIG. 1 is a block diagram illustrating one configuration of a wireless communication system 100 in which systems and methods for controlling receive diversity for wireless personal area network (WPAN) communication may be implemented. Wireless communication systems 100 may be deployed to provide various types of communication content such as voice, data, and so on. A wireless communication system 100 may include a wireless communication device 102 and a remote device 126. The remote device 126 may include one or more antennas 128 for communicating wirelessly with the wireless communication device 102 (e.g., for transmitting and/or receiving signals 130).

Some mobile devices may utilize one or more WPAN communication technologies. Examples of WPAN communication technologies may include Bluetooth (BT), Institute of Electrical and Electronics Engineers (IEEE) 802.15.4, ZigBee, Wireless Universal Serial Bus (USB), Z-Wave, etc. The wireless communication device 102 may implement one or more WPAN communication technologies.

A wireless communication device 102 may also be referred to as a wireless device, a mobile device, mobile station, subscriber station, client, client station, user equipment (UE), remote station, access terminal, mobile terminal, terminal, user terminal, subscriber unit, a master, a slave, etc. Examples of wireless communication devices 102 include cellular phones, smart phones, tablet devices, headsets (e.g., wireless headsets), wireless ear buds, laptop or desktop computers, wireless modems, e-readers, gaming systems, vehicles (e.g., automobile electronics, automobile consoles, etc.), drones, aircraft, robots, medical equipment, remotely operated devices (e.g., vehicles, robots, drones, toys, etc.), televisions, appliances, cameras, etc. Some of these devices may operate in accordance with one or more industry standards. More specific examples of the wireless communication device 102 may include a BT headset, BT speakers, a BT microphone, a BT speakerphone, and a BT hands-free car kit.

Communications in the wireless communication system 100 may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. Improved performance (e.g., higher throughput, increased range, greater capacity, and/or improved reliability) may be achieved if the additional dimensionalities created by the multiple transmit and/or receive antennas are utilized.

The wireless communication device 102 may communicate with a remote device 126. For example, the wireless communication device 102 may transmit one or more signals 130 to and/or may receive one or more signals 130 from the remote device 126. Examples of the signals 130 may include packets (e.g., advertising packets, connection setup packets, connection packets, etc.), beacons, synchronization signals, data, audio (e.g., music, voice calls, etc.), speech, video, etc.

The communication between the wireless communication device 102 and the remote device 126 may be bi-directional or uni-directional. For example, the wireless communication device 102 and the remote device 126 may transmit signals to and receive signals from each other. In another example, the remote device 126 may only transmit signals 130 to the wireless communication device 102 and the wireless communication device 102 may only receive signals 130 from the remote device 126.

It should be noted that the wireless communication device 102 may communicate with one or more other devices in some configurations. For example, the wireless communication device 102 may implement wireless local area network (WLAN) and/or cellular technologies to communicate with other devices. These other communications may be performed separately from WPAN communications in some approaches.

In some configurations, the wireless communication device 102 may include a processor 104, a memory 114, and/or one or more receivers 120. The processor 104 may be coupled to (e.g., in electronic communication with) the memory 114, and/or the receiver(s) 120. It should be noted that one or more of the elements illustrated in FIG. 1 may be optional. In particular, the wireless communication device 102 may not include one or more of the elements illustrated in FIG. 1 in some configurations. For example, the wireless communication device 102 may or may not include a performance target obtainer 110 and/or a signal quality determiner.

The memory 114 may store instructions and/or data. The processor 104 may access (e.g., read from and/or write to) the memory 114. Examples of instructions and/or data that may be stored by the memory 114 may include one or more stored packet types 116, one or more receiver sensitivities 118, received packet data, packet type determiner 106 instructions, diversity setting determiner 108 instructions, performance target obtainer 110 instructions, signal quality determiner instructions, diversity processor 122 instructions, and/or instructions for other elements, etc. In some configurations, the wireless communication device 102 (e.g., the memory 114) may include a packet data buffer (not shown). The packet data buffer may buffer (e.g., store) received packet data (from the receiver(s) 120, for example).

The receiver(s) 120 may enable the wireless communication device 102 to receive signals 130 from one or more remote devices 126. For example, the receiver(s) 120 may provide an interface for wireless communications. The receiver(s) 120 may be coupled to one or more antennas 124a-b for receiving radio frequency (RF) signals. The receiver(s) 120 may be set to operate in a diversity state or a non-diversity state. For example, the receiver(s) 120 may utilize multiple antennas 124a-b (e.g., two or more antennas) while operating in a diversity state (in accordance with a diversity-enabled setting, for example). The receiver(s) 120 may utilize a single antenna 124a (e.g., only one antenna) while operating in a non-diversity state (in accordance with a diversity-disabled setting, for example).

In some configurations, the receiver(s) 120 may include multiple receive chains. A receive chain may include one or more elements (e.g., an amplifier, analog-to-digital converter (ADC), down-converter, and/or demodulator, etc.). In some approaches, one or more receive chains may be disabled (e.g., deactivated) while operating in a non-diversity state (in accordance with a diversity-disabled setting, for example). For instance, only one WPAN receive chain may be enabled (e.g., active, activated, etc.) while operating in a non-diversity state (in accordance with a diversity-disabled setting, for example). Additionally or alternatively, two or more receive chains may be enabled (e.g., active, activated, etc.) while operating in a diversity state (in accordance with a diversity-enabled setting, for example). For instance, multiple WPAN receive chains may be active while operating in a diversity state (in accordance with a diversity-enabled setting, for example).

The receiver(s) 120 may include a diversity processor 122. The diversity processor 122 may process received signals from multiple (e.g., two or more) antennas 124a-b when operating in a diversity state. For instance, the diversity processor 122 may phase shift one or more received signals from the multiple antennas 124a-b and/or may combine multiple received signals from the multiple antennas 124a-b in some approaches. In some configurations, the diversity processor 122 may implement a maximum ratio combiner (MRC) with two or more radio receivers 120 and antennas 124a-b. In some approaches, the diversity processor 122 may be disabled (e.g., deactivated) while in a non-diversity state (in accordance with a diversity-disabled setting, for example) and/or may be enabled (e.g., activated) while in a diversity state.

In some configurations, the wireless communication device 102 may also include one or more transmitters (not shown) for transmitting signals 130 to the remote device 126. The receiver(s) 120 and the transmitter(s) may be referred to as one or more transceivers in some implementations.

In some configurations, multiple communication interfaces may be implemented and/or utilized. For example, one communication interface (including the receiver(s) 120, for example) may be a WPAN communication interface, another communication interface may be a cellular (e.g., third-generation (3G), Long Term Evolution (LTE), CDMA, etc.) interface, and yet another communication interface may be a wireless local area network (WLAN) interface (e.g., Institute of Electrical and Electronics Engineers (IEEE) 802.11 interface). In some implementations, multiple communication interfaces may share one or more antennas 124a-b.

The processor 104 may include and/or implement a packet type determiner 106, a diversity setting determiner 108, a performance target obtainer 110 and/or an optional signal quality determiner (not shown). It should be noted that one or more of the elements illustrated in the wireless communication device 102 and/or processor 104 may be optional. For example, the packet type determiner 106, the performance target obtainer 110 and/or the signal quality determiner may or may not be included and/or implemented.

In some configurations, one or more of the elements illustrated in the processor 104 may be implemented separately from the processor 104 (e.g., in other circuitry, on another processor, etc.). For example, the packet type determiner 106, the diversity setting determiner 108, the performance target obtainer 110 and/or the signal quality determiner may be implemented on multiple processors and/or on a combination of processors.

The processor 104 may include and/or implement the packet type determiner 106. The packet type determiner 106 may determine a packet type. For example, the packet type determiner 106 may determine at least one packet type for WPAN communication. Determining the packet type may include determining a packet type for receive (Rx) communications with the remote device 126. For example, the packet type may indicate a type of packet that is anticipated to be received (from the remote device 126, for instance).

In some configurations, the packet type may imply static receiver characteristics (e.g., receiver sensitivity). For example, the packet type may indicate one or more encodings, modulation constellations, structures, etc. In some approaches, the packet type may be based on static (e.g., predetermined, specified, etc.) aspects. The receive characteristics (e.g., receiver sensitivity) may be a static (e.g., predetermined) value and/or may not be based on active signaling (e.g., may not be measured based on active traffic).

In some configurations, the wireless communication device 102 (e.g., packet type determiner 106) may determine a particular packet type for subsequent WPAN communications. For example, the packet type determiner 106 may determine a packet type for subsequent connection setup and/or may determine a packet type for subsequent connection.

In some configurations, the packet type for a communication may be indicated by a communication profile and/or a WPAN profile stored on the wireless communication device 102 (e.g., memory 114). For example, the communication profile and/or the WPAN profile may indicate packet settings and/or user preferences that indicate one or more packet types for use in communication. The packet type determiner 106 may determine the packet type(s) by reading the communication profile and/or WPAN profile in some configurations.

In some configurations, the wireless communication device 102 (e.g., packet type determiner 106) may determine a packet type for subsequent communications based on higher layer software. For example, higher layer software (e.g., one or more applications) may indicate and/or limit the packet types for scan, connection setup, and/or connection. Additionally or alternatively, the packet types may be pre-programmed (e.g., predetermined).

In some approaches, determining a packet type for subsequent WPAN communications may be performed in accordance with one or more of the following aspects. The packet type determination may be an antecedent packet type determination. For example, the packet type determination may be performed before communicating using the packet type (e.g., before receiving a packet of the packet type). It should be noted that in some cases and/or configurations, other previous communications using the packet type may have already been carried out, but those communications may be unrelated to, may be in a different previous instance from, and/or may be a separate communication in relation to the anticipated (e.g., subsequent, next, etc.) communication. Additionally or alternatively, the packet type determination may be a pre-active packet type determination. For example, the packet type determination may indicate one or more packet types for a communication that is not yet active (e.g., that is not being currently performed). Additionally or alternatively, the packet type determination may be associated with a future (e.g., later) communication. Additionally or alternatively, the packet type determination may be performed before a connection is established (e.g., pre-connection) with a remote device 126. In some configurations, packet types that may be scanned and/or that may be used for connection setup may be limited in each WPAN technology. For example, a BLE device may be programmed to scan for one or more of the advertising packet types by higher layer software. In some approaches, one or more packets for the subsequent communication may be referred to as next packet(s) and/or subsequent packets.

A packet type may indicate (e.g., identify) a kind of packet. For example, a packet type may indicate a kind of packet in a set of predetermined (e.g., known) packet types. In some approaches, packet type may correspond to a packet scheme (e.g., standard). For instance, one or more packet types may correspond to BT Classic, one or more packet types may correspond to BT Low Energy, one or more packet types may correspond to BT Long Range, one or more packet types may correspond to IEEE 802.15.4, and/or one or more packet types may correspond to custom packets (e.g., proprietary packets), etc. In some configurations, the memory 114 may include stored packet types 116. For example, the stored packet types 116 may indicate a set of predetermined (e.g., known) packet types.

Some packet types may be utilized for connection setup, which may be referred to as “connection setup packets” or “setup packets.” Some packet types may be utilized for connection (e.g., payload delivery), which may be referred to as “connection packets.” Examples of packet types may include BT classic 1 megabit per second (Mbps) setup packets, BT 2 Mbps enhanced data rate (EDR) connection packets, BT 3 Mbps EDR connection packets (e.g., “EDR3”), BT Long Range setup packets, BT Low Energy (“BTLE” or “BLE”) 1 Mbps setup packets, BTLE connection packets (e.g., BTLE 2 Mbps connection packets), 15.4 setup packets, custom setup packets (e.g., proprietary setup packets), custom connection packets (e.g., proprietary connection packets), connection packets with forward error correction (FEC), etc.

The processor 104 may include and/or implement the diversity setting determiner 108. The diversity setting determiner 108 may determine at least one receive diversity setting based on the at least one packet type. For example, the packet type determiner 106 may provide the determined packet type to the diversity setting determiner 108. The diversity setting determiner 108 may use the obtained packet type(s) to determine one or more diversity settings.

In some approaches, the diversity setting determiner 108 may determine one or more diversity settings for each packet type. For example, the diversity setting determiner 108 may determine one diversity setting for each packet type or may determine multiple diversity settings for each packet type. For instance, one diversity setting may be used for a whole packet or different diversity settings may be used for portions (e.g., an acquisition portion and a demodulation portion) of a packet.

In some configurations, the diversity setting determiner 108 may perform an antecedent diversity setting determination. For example, the diversity setting determiner 108 may determine one or more diversity settings for a subsequent communication before scanning, before receiving connection setup packet(s), and/or before receiving connection packet(s). Additionally or alternatively, the antecedent diversity setting determination may be based only on pre-communication information. For example, the antecedent diversity setting determination may be based on predetermined receiver (e.g., receiver(s) 120) characteristic(s) and/or may be based on predetermined packet type characteristic(s) (e.g., encoding type, modulation, range, etc.). In some configurations, the antecedent diversity setting determination may not be based on any signal characteristic (e.g., retransmission rate, packet error rate, signal quality, received signal strength indicator (RSSI), packet statistics, etc.) that is measured or observed based on signaling with the remote device 126. For example, the antecedent diversity setting determination may not be based on runtime (e.g., real-time) signal measurement and/or observation. In some configurations, the antecedent diversity setting determination may not be based on packet size and/or inter-packet spacing. In some configurations, the antecedent diversity setting determination may be performed based on a packet type for a communication before the packet type is utilized (e.g., sent and/or received) in the communication. Additionally or alternatively, the antecedent diversity setting determination may be performed independently from any signal measurement (e.g., feedback) and/or from diversity setting based on signal measurement (e.g., feedback).

In some configurations, the diversity setting determiner 108 may determine the one or more diversity settings based on one or more receiver sensitivities associated with each packet type. For example, the diversity setting determiner 108 may determine one or more receiver sensitivities associated with each packet type. For instance, each packet type may correspond to multiple receiver settings for a diversity-enabled setting and a diversity-disabled setting (for whole packets and/or for portions of a packet). In some configurations, the diversity setting determination (e.g., antecedent diversity setting determination, packet type lookup, etc.) may be performed at the media access control (MAC) layer.

In some approaches, each packet type may correspond to four receiver sensitivities: a diversity-enabled acquisition portion receiver sensitivity, a diversity-disabled acquisition portion receiver sensitivity, a diversity-enabled demodulation portion receiver sensitivity and a diversity-disabled demodulation portion receiver sensitivity. In some configurations, the diversity setting determiner 108 may obtain all receiver sensitivities corresponding to a packet type. In some configurations, the diversity setting determiner 108 may obtain a subset of all receiver sensitivities corresponding to the packet type. For example, the diversity setting determiner 108 may obtain one or more receiver sensitivities corresponding to a state (e.g., a current state, a diversity state or a non-diversity state, a state for acquisition and/or a state for demodulation, etc.).

In some implementations, the memory 114 may include stored packet types 116 and stored receiver sensitivities 118 (e.g., corresponding receiver sensitivities). In some configurations, the stored receiver sensitivities 118 may be predetermined (e.g., predetermined based on receiver(s) 120 specifications, receiver(s) 120 calibration, etc.). The diversity setting determiner 108 may determine (e.g., look up) one or more stored receiver sensitivities 118 based on the packet type(s). For example, the diversity setting determiner 108 may use the packet type(s) provided by the packet type determiner 106 to find a corresponding (e.g., matching) stored packet type 116. The corresponding stored packet type 116 may be associated with one or more stored receiver sensitivities 118. For example, each of the stored packet types 116 may correspond to at least one stored receiver sensitivity 118. In some approaches, a stored packet type 116 may correspond to multiple receiver sensitivities 118 for different packet portions. For example, one stored packet type 116 may correspond to a stored receiver sensitivity 118 for an acquisition portion of the packet and to a stored receiver sensitivity 118 for a demodulation portion of the packet. Additionally or alternatively, a stored packet type 116 may correspond to a stored receiver sensitivity 118 for a diversity-enabled setting and a receiver sensitivity 118 for a diversity-disabled setting. For example, the diversity setting determiner 108 may look up a diversity-enabled acquisition portion receiver sensitivity, a diversity-disabled acquisition portion receiver sensitivity, a diversity-enabled demodulation portion receiver sensitivity and/or a diversity-disabled demodulation portion receiver sensitivity for one or more packet types.

In some configurations, the diversity setting determiner 108 may determine the one or more diversity settings based on one or more receiver sensitivities. In some approaches, the diversity setting determiner 108 may compare receiver sensitivities between packets and/or between packet portions to determine the diversity setting(s). For example, the diversity setting determiner 108 may compare a setup packet receiver sensitivity to a connection packet receiver sensitivity. For instance, if the setup packet receiver sensitivity is greater than the connection packet receiver sensitivity, the diversity setting determiner 108 may determine a diversity-disabled setting for one or more setup packets (and/or for scan) and may determine a diversity-enabled setting for one or more connection packets. Alternatively, if the setup packet receiver sensitivity is not greater than (e.g., is less than or equal to) the connection packet receiver sensitivity, the diversity setting determiner 108 may determine a diversity-enabled setting for one or more setup packets (and/or for scan) and may determine a diversity-disabled setting for one or more connection packets. The wireless communication device 102 (e.g., the receiver(s)) may apply the diversity setting(s). For instance, the wireless communication device 102 may perform inter-packet diversity switching between packets (when communicating with the remote device 126, for example).

In another example, the diversity setting determiner 108 may compare a packet receiver sensitivity for acquisition (e.g., packet acquisition receiver sensitivity) to a packet receiver sensitivity for demodulation (e.g., packet demodulation receiver sensitivity). For instance, if the packet receiver sensitivity for acquisition is less than the packet receiver sensitivity for demodulation, the diversity setting determiner 108 may determine a diversity-enabled setting for packet acquisition and may determine a diversity-disabled setting for packet demodulation. Alternatively, if the packet receiver sensitivity for acquisition is not less than (e.g., is greater than or equal to) the sensitivity for demodulation, the diversity setting determiner 108 may determine a diversity-disabled setting for packet acquisition and may determine a diversity-enabled setting for demodulation. The wireless communication device 102 (e.g., the receiver(s)) may apply the diversity setting(s). For instance, the wireless communication device 102 may perform intra-packet diversity switching between portions of one or more packets.

In some configurations, the diversity setting determiner 108 may determine one or more diversity settings based on a performance target. A performance target may indicate one or more performance objectives and/or one or more performance thresholds. For instance, a performance objective may be an aspect of performance for prioritization, improvement and/or optimization (e.g., maximization or minimization), etc. Examples of performance objectives may include range, data speed (during connection, for instance), power savings (during setup, during connection, during acquisition and/or during demodulation, for instance), power consumption, signal quality, reliability, balance, balanced range (e.g., similar range between setup and connection and/or between acquisition and demodulation), setup range (e.g., higher connection setup range), high (e.g., maximum) range during connection, high (e.g., maximum) sensitivity during acquisition, etc. A performance threshold may indicate a threshold of performance for one or more performance aspects. Examples of performance thresholds may include a signal quality threshold (e.g., signal strength threshold, packet error rate threshold, retransmission threshold, etc.), a reliability threshold, a power savings threshold, a power consumption threshold, a data speed threshold and/or a range threshold, a balance threshold, etc. The diversity setting determiner 108 may determine one or more diversity settings in order to meet the performance target. The performance target (e.g., performance objective(s) and/or performance threshold(s)) may be utilized for (e.g., during) antecedent diversity setting determination and/or for (e.g., during) subsequent communications.

In some configurations, the diversity setting determiner 108 may disable diversity for one or more packet types and/or packet portions if diversity is not needed to meet the performance target and/or if enabling diversity will not significantly improve performance with respect to the performance target (e.g., range, data speed, link quality, reliability, etc.). Additionally or alternatively, the diversity setting determiner 108 may enable diversity for some one or more packet types and/or packet portions in order to maintain communication even though disabling diversity may enable meeting the performance target (e.g., power savings).

In some configurations, the wireless communication device 102 (e.g., receiving communication device) may maintain a record (e.g., table, lookup table, other data structure, etc.) of a receiver configuration (e.g., optimal receiver configuration) for each packet type and/or a portion of a packet type. The receiver configuration may be used at different times during connection setup and connection. The record (e.g., table) may be filled at design time based on knowledge of the receiver performance and/or power consumption. The wireless communication device 102 (e.g., diversity setting determiner 108) may apply the settings from the record (e.g., table) for each received packet. In some approaches, the receiver configurations (e.g., optimal receiver configuration) may enable the receiver(s) 120 to provide similar operating range at each stage of the communication (e.g., setup, connection, etc.), and/or for acquisition and demodulation of each packet type. For example, a performance target may indicate balanced range as a performance objective, which may be met by one or more of the receiver configurations in the record. It should be noted that other performance targets (e.g., “optimal” performance) may be different for different kinds of end products for weighing power consumption versus sensitivity.

Table (1) provides examples of receiver sensitivities according to packet type for an example of a receiver. In Table (1), data rates are expressed in kilobits per second (kbps), receiver sensitivities are expressed in decibel milliwatt units (dBm) and power (e.g., power consumption) is expressed in milliwatts (mW).

TABLE (1)

| | | No | | | |
|---|---|---|---|---|---|
| Packet Type | | Diversity | | Diversity | |
| BLE Long Range 125 kbps | Acquisition | −90 | dBm | −93 | dBm |
| | Demodulation | −94 | dBm | −97 | dBm |
| | Power | 5 | mW | 7 | mW |
| BLE Long Range 500 kbps | Acquisition | −89 | dBm | −91 | dBm |
| | Demodulation | −90 | dBm | −92 | dBm |
| | Power | 6 | mW | 8 | mW |

Table (2) provides examples of receiver configurations. For instance, a designer may set a receiver configuration table in accordance with Table (2) in some implementations.

TABLE (2)

| Packet Type | | Diversity Setting |
|---|---|---|
| BLE Long Range 125 kbps | Acquisition | Diversity |
| | Demodulation | No Diversity |
| BLE Long Range 500 kbps | Acquisition | No Diversity |
| | Demodulation | No Diversity |

For example, the 125 kbps diversity settings may provide maximum operating range for the wireless communication device 102 at 125 kbps (with a −93 dBm receiver sensitivity based on a range performance objective). In another example, the 500 kbps diversity settings may provide lowest power consumption with a small compromise in sensitivity (e.g., −89 dBm receiver sensitivity based on a power saving performance objective) at a 500 kbps rate. It should be noted that other settings may be utilized for other performance objectives.

In some configurations, the diversity setting determiner 108 may determine (e.g., look up) diversity settings (e.g., predetermined diversity settings) based on the packet type and/or based on a performance objective. For example, a record (e.g., lookup table) may include predetermined diversity settings for different packet types and/or packet type combinations. The predetermined diversity settings may be based on predetermined receiver sensitivities. The diversity setting determiner 108 may determine (e.g., look up) diversity settings based on the determined packet type(s) and/or may apply the diversity settings during a communication (e.g., subsequent communication). Additionally or alternatively, the diversity setting determiner 108 may determine (e.g., look up) diversity settings based on the determined packet type(s) and based on a performance target (e.g., performance objective). For example, the record may include different diversity settings for the same or different packet types based on different performance targets (e.g., performance objectives).

In some configurations, the processor 104 may include and/or implement a performance target obtainer 110. The performance target obtainer 110 may obtain (e.g., determine and/or receive) a performance target. In some approaches, the performance target obtainer 110 may receive one or more inputs that indicate one or more performance targets. For example, the wireless communication device 102 may receive one or more inputs that indicate one or more performance targets. In some implementations, the wireless communication device 102 may include a user interface that may receive user input that indicates user preferences and/or settings, which may indicate one or more performance targets. For example, a user input may indicate a preference for one or more of range, data speed, power savings, link quality, reliability, balance, etc. Additionally or alternatively, the wireless communication device 102 may receive a signal from a remote device (e.g., remote device 126 or another remote device) indicating one or more performance targets.

In some configurations, the wireless communication device 102 may present a user interface on a display. For example, the wireless communication device 102 may include or may be coupled to a display and may provide a user interface on the display, where the user interface enables a user to interact with the wireless communication device 102. In some configurations, the display may be a touchscreen that receives input from physical touch (by a finger, stylus, or other tool, for example). Additionally or alternatively, the wireless communication device 102 may include or be coupled to another input interface. For example, the wireless communication device 102 may include a camera facing a user and may detect user gestures (e.g., hand gestures, arm gestures, eye tracking, eyelid blink, etc.). In another example, the wireless communication device 102 may be coupled to a mouse and may detect a mouse click. Other examples of user interfaces may include one or more buttons, a keypad, a microphone (for capturing sounds, speech, etc.), a motion detector, etc. One or more of these user interfaces may be implemented to receive input that indicates one or more performance targets.

In some approaches, the performance target obtainer 110 may determine one or more performance targets based on one or more factors in addition to or alternatively from received input. For example, the performance target obtainer 110 may determine a performance target based on one or more factors (e.g., current battery charge, communication data type (e.g., voice call, video, audio, webpage data, etc.), communication data size (e.g., file transfer size), quality of service (QoS), etc.

The performance target and the packet type may be utilized to determine the one or more receive diversity settings in some configurations. In particular, the diversity setting determiner 108 may attempt to meet the performance target in determining the diversity setting(s). For example, if the performance target is power savings (e.g., longer battery life), the diversity setting determiner 108 may disable diversity for one or more packet types and/or packet portions in order to reduce power consumption. In some approaches, diversity may be disabled to reduce power consumption only while communication (e.g., a wireless link) may be maintained with the remote device 126. For instance, the diversity setting determiner 108 may still enable diversity for one or more packets and/or packet portions if disabling diversity may jeopardize the link.

In another example, the performance target may be range. For instance, the diversity setting determiner 108 may determine one or more diversity settings to prioritize (e.g., maximize) range. In some approaches, the diversity setting determiner 108 may initially activate diversity for scan and/or setup packets in order to prioritize range. Additionally or alternatively, the diversity setting determiner 108 may activate diversity for connection packets in order to prioritize range. It should be noted that in some approaches, the diversity setting determiner 108 may not simply activate diversity for all packet types and/or packet portions when range is the performance target. For example, if the connection packet type is more robust (e.g., provides greater sensitivity) than the setup packet type, the diversity setting determiner 108 may disable diversity for connection packets, since diversity may not be needed to maintain good performance. However, if signal quality degrades during connection, the diversity setting determiner 108 may enable diversity to extend range performance and/or to maintain link quality.

It should be noted that the diversity setting determination (e.g., antecedent diversity setting determination) may be performed without a performance target in some configurations. For example, diversity setting determination (e.g., antecedent diversity setting determination) may be performed based on the packet type(s) without a performance target. The receiver(s) 120 and/or diversity processor 122 may operate to receive and/or processor one or more packets (of a communication, for example) in accordance with the diversity settings (provided by the diversity setting determiner 108, for example).

In some configurations, the wireless communication device 102 (e.g., receiver(s) 120) may perform a scan to discover one or more remote devices 126. The wireless communication device 102 may receive one or more advertising packets, a beacon signal, an identifier signal, etc., from the remote device 126. For example, a remote device 126 may transmit (e.g., broadcast) a signal for pairing and/or for connection setup, etc.

In some configurations, the processor 104 may optionally include and/or implement a signal quality determiner (not shown). The signal quality determiner may determine a signal quality measure based on the signals 130. For example, the signal quality determiner may receive and/or determine a signal strength (e.g., a received signal strength indicator (RSSI)), a packet error rate, a bit error rate, a number (e.g., proportion) of retransmissions, data speed, etc. For instance, the diversity setting determiner 108 may perform antecedent diversity setting determination before sending and/or receiving signal(s) 130 for a communication. The diversity setting(s) may be applied for the subsequent communication. The signal quality measure may be determined based on the signal(s) 130 of the subsequent communication. It should be noted that in some configurations, the signal quality determiner may not be included. It should also be noted that antecedent diversity setting determination may not use any signal quality measure to determine the diversity setting in some approaches. In some approaches, signal quality determination may be performed only after the antecedent diversity setting determination or not at all.

In some configurations, the diversity setting determiner 108 may perform subsequent (e.g., runtime) diversity setting determination (e.g., adjustment). For example, the diversity setting determiner 108 may determine one or more diversity settings (e.g., subsequent diversity setting(s), runtime diversity setting(s), adjusted diversity setting(s), etc.) based on the signal quality measure. For instance, the diversity setting determiner 108 may compare the signal quality measure to a performance threshold (e.g., signal strength threshold, RSSI threshold, packet error rate threshold, retransmission threshold, data speed threshold, etc.). The diversity setting determiner 108 may determine the diversity setting(s) based on whether the performance threshold is met. For example, if diversity is disabled for connection packets but the signal quality measure (e.g., signal strength) falls below a signal strength threshold, the diversity setting determiner 108 may enable diversity for connection packets in order to improve signal quality.

In some configurations, the wireless communication device 102 may be a Bluetooth (BT) device. For example, the wireless communication device 102 may include a BT transceiver that includes a BT transmitter and a BT receiver (an example, of the receiver(s) 120) that are configured to send and receive BT signals, respectively. The wireless communication device 102 may be paired with the remote device 126. For example, the wireless communication device 102 may establish a BT connection with the remote device 126.

The BT transceiver may establish links with one or more remote BT devices. Bluetooth is a packet-based protocol with a master-slave structure. Bluetooth operates in the Industrial, Scientific and Medical (ISM) 2.4 gigahertz (GHz) short-range radio frequency band (e.g., 2400-2483.5 megahertz (MHz)). Bluetooth may use a radio technology called frequency-hopping spread spectrum in which transmitted data is divided into packets and each packet is transmitted on a designated Bluetooth frequency (e.g., channel). The wireless communication device 102 may include one or more antennas 124a-b configured to transmit and receive Bluetooth signals.

In some approaches, communications in a Bluetooth network may be achieved based on a master polled system. The master polled system may utilize time-division duplexing (TDD) in which the master (e.g., wireless communication device 102 or remote device 126) may send a packet to the slave. In a master polled system, the master device sending the packet gives the slave wireless device the ability to transmit back.

The wireless communication device 102 and the remote device 126 may establish a link using one or more BT protocols. For transmitting general data packets, the BT link may be an asynchronous connection-less (ACL) link. For speech data, for example, the BT link may be a synchronous connection-oriented (SCO) link or an enhanced SCO (eSCO) link. An SCO/eSCO link may include a set of reserved timeslots on an existing ACL link. The wireless communication device 102 and/or the remote device 126 may transmit encoded speech data in the reserved timeslot.

To enhance security, the wireless communication device 102 and remote device 126 may use pairing to establish a connection. In one configuration, the wireless communication device 102 may establish a relationship with a remote device 126 by sharing a link key. In an implementation, the link key may be a paired device profile. If both the wireless communication device 102 and the remote device 126 store the same link key, they are said to be paired devices. The paired devices may cryptographically authenticate the identity of the other device, ensuring it is the same device it previously paired with. Once a link key is generated, the wireless communication device 102 and remote device 126 may encrypt exchanged data.

It should be noted that one or more of the elements or components of the wireless communication device 102 may be combined and/or divided. For example, one or more of the packet type determiner 106, the diversity setting determiner 108, the performance target obtainer 110, the signal quality determiner and/or the diversity processor 122 may be combined. Additionally or alternatively, one or more of the packet type determiner 106, the diversity setting determiner 108, the performance target obtainer 110, the signal quality determiner and/or the diversity processor 122 may be divided into elements or components that perform a subset of the operations thereof.

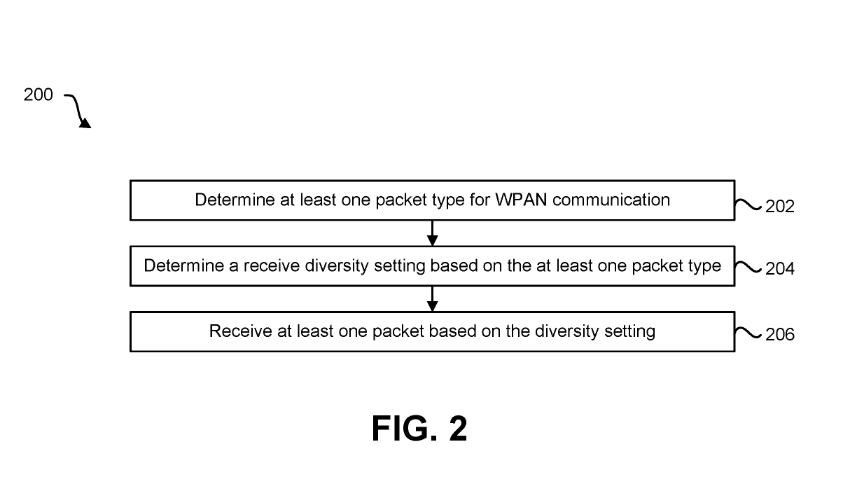

FIG. 2 is a flow diagram illustrating a method 200 for controlling receive diversity for WPAN communication. The method 200 may be performed by the wireless communication device 102 described in connection with FIG. 1. The wireless communication device 102 may determine 202 at least one packet type for WPAN communication. This may be accomplished as described in connection with FIG. 1. For example, the wireless communication device 102 may determine 202 at least one packet type for a subsequent WPAN communication.

The wireless communication device 102 may determine 204 a receive diversity setting based on the at least one packet type. This may be accomplished as described in connection with FIG. 1. For example, the wireless communication device 102 may determine diversity setting(s) corresponding to the packet type(s) and/or to portions of packet(s) (of the packet type(s), for instance).

The wireless communication device 102 may receive 206 at least one packet based on the diversity setting. This may be accomplished as described in connection with FIG. 1. For example, the wireless communication device 102 may control a receiver to enable and/or disable diversity in accordance with the previously determined 204 diversity setting(s) while receiving one or more packets from a remote device. For instance, the one or more packets may be received during a subsequent communication (e.g., one or more subsequent packets) based on the antecedent diversity setting determination.

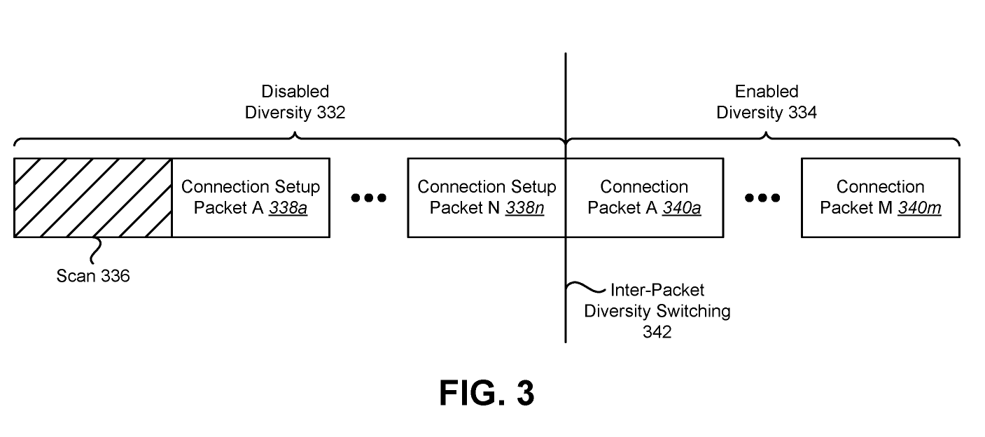

FIG. 3 illustrates an example of inter-packet diversity switching 342. In particular, FIG. 3 illustrates a scan 336, one or more connection setup packets 338a-n and one or more connection packets 340a-m. In this example, the wireless communication device 102 may perform antecedent diversity setting determination to determine a connection setup packet type and a connection packet type before the scan 336 (e.g., one or more scans).

Based on the connection setup packet type and the connection packet type, the wireless communication device 102 may determine that the connection setup packet(s) 338a-n will be more robust than the connection packet(s) 340a-m. The wireless communication device 102 may determine to apply disabled diversity 332 during the scan 336 (e.g., one or more scans) and the connection setup packet(s) 338a-n. Additionally or alternatively, the wireless communication device 102 may determine to apply enabled diversity 334 during the connection packet(s) 340a-m. For example, the wireless communication device 102 may perform inter-packet diversity switching 342 to enable diversity between the connection setup packet(s) 338a-n and the connection packet(s) 340a-m. In some approaches, diversity may be enabled during connection to balance range performance.

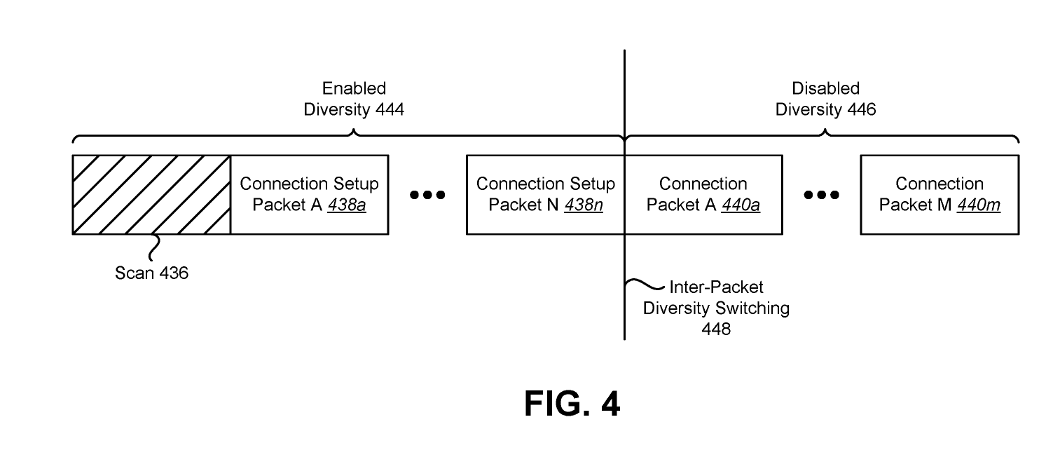

FIG. 4 illustrates another example of inter-packet diversity switching 448. In particular, FIG. 4 illustrates a scan 436, one or more connection setup packets 438a-n and one or more connection packets 440a-m. In this example, the wireless communication device 102 may perform antecedent diversity setting determination to determine a connection setup packet type and a connection packet type before the scan 436 (e.g., one or more scans).

Based on the connection setup packet type and the connection packet type, the wireless communication device 102 may determine that the connection setup packet(s) 438a-n will be less robust than the connection packet(s) 440a-m. The wireless communication device 102 may determine to apply enabled diversity 444 during the scan 436 (e.g., one or more scans) and the connection setup packet(s) 438a-n. Additionally or alternatively, the wireless communication device 102 may determine to apply disabled diversity 446 during the connection packet(s) 440a-m. For example, the wireless communication device 102 may perform inter-packet diversity switching 448 to disable diversity between the connection setup packet(s) 438a-n and the connection packet(s) 440a-m. In some approaches, diversity may be disabled during connection to balance range performance.

In some configurations, the wireless communication device 102 may determine a signal quality measure based on the received connection packet(s) 440a-m. The wireless communication device 102 may enable (e.g., re-enable) diversity during the connection packet(s) 440a-m if a link quality drop (e.g., a link quality drop beyond a threshold) occurs.

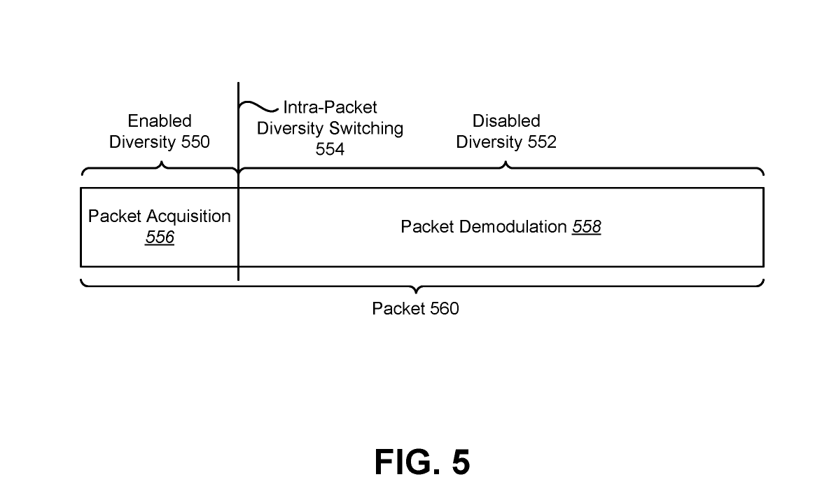

FIG. 5 illustrates an example of intra-packet diversity switching 554. In particular, FIG. 5 illustrates a packet 560 than includes a packet acquisition portion 556 and a packet demodulation portion 558. In this example, the wireless communication device 102 may perform antecedent diversity setting determination to determine a packet type of the packet 560.

Based on the packet type, the wireless communication device 102 may determine that the packet acquisition 556 receiver sensitivity will be lower than the demodulation 558 receiver sensitivity. The wireless communication device 102 may determine to apply enabled diversity 550 during the packet acquisition portion 556. Additionally or alternatively, the wireless communication device 102 may determine to apply disabled diversity 552 during the packet demodulation 558. For example, the wireless communication device 102 may perform intra-packet diversity switching 554 to disable diversity between the packet acquisition portion 556 and the packet demodulation portion 558. In some approaches, diversity may be enabled during packet acquisition 556 only to save power during demodulation and/or to balance acquisition and demodulation performance.

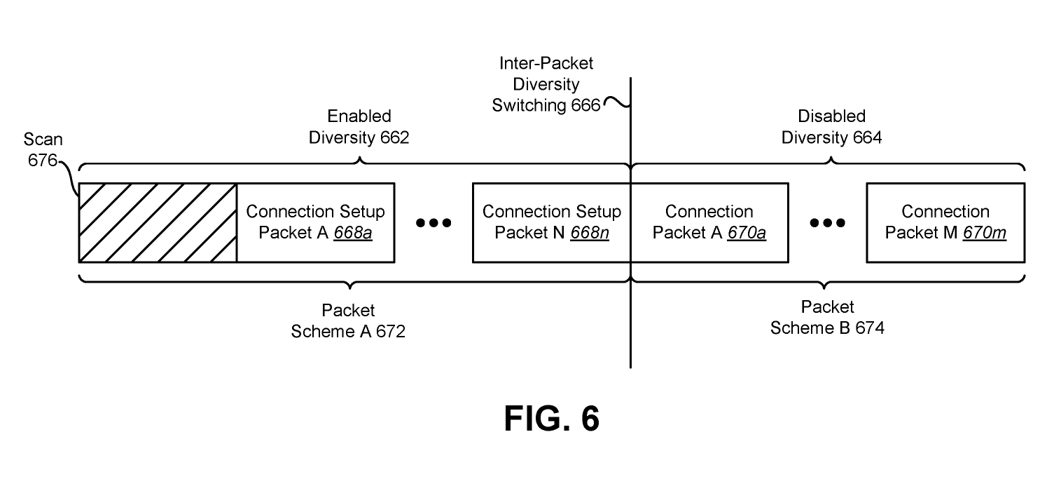

FIG. 6 illustrates yet another example of inter-packet diversity switching 666. In particular, FIG. 6 illustrates a scan 676, one or more connection setup packets 668a-n and one or more connection packets 670a-m. In this example, the wireless communication device 102 may perform antecedent diversity setting determination to determine a connection setup packet type and a connection packet type before the scan 676 (e.g., one or more scans).

In this example, the connection setup packet type may correspond to packet scheme A 672 and the connection packet type may correspond to packet scheme B 674. A packet scheme may include one or more packet types. In some configurations, a packet scheme may include one or more packet types in accordance with a standard. For example, a BT Long Range packet scheme may include a BT Long Range connection setup packet type and a BT Long Range connection packet type. In another example, a BT Low Energy packet scheme may include a BT Low Energy connection setup packet type and a BT Low Energy connection packet type. In yet another example, a BT classic packet scheme may include a BT classic connection setup packet type and a BT classic connection packet type. In yet another example, a 15.4 packet scheme may include a 15.4 connection setup packet type and a 15.4 connection packet type. In yet another example, a BT EDR scheme may include a BT EDR setup packet type and a BT EDR packet type. Other packet schemes may include one or more packet types (e.g., proprietary packet types, custom packet types, etc.).

One benefit of some configurations of the systems and methods disclosed herein is the ability to utilize (e.g., mix, combine, etc.) packet types of different packet schemes. As illustrated in FIG. 6, the scan 676 and/or connection setup packets 668a-n may be from packet scheme A 672 (e.g., from a first standard) and the connection packets 670a-m may be from packet scheme B 674 (e.g., from a second standard). For example, the wireless communication device 102 may utilize a connection setup packet type from one packet scheme and may utilize a connection packet type from a different packet scheme. In some configurations, packet scheme A 672 and packet scheme B 674 may be different BT standards. In some configurations, packet scheme A 672 may be a standard with standard connection setup packets and packet scheme B 674 may include a proprietary packet type or an advanced standard packet type. Other variations may be utilized and/or implemented. Controlling diversity between the packet types from different packet schemes may allow beneficial (e.g., efficient, long range, etc.) combinations of packet schemes.

For example, based on the connection setup packet type from packet scheme A 672 and the connection packet type from packet scheme B 674, the wireless communication device 102 may determine that the connection setup packet(s) 668a-n will be less robust than the connection packet(s) 670a-m. The wireless communication device 102 may determine to apply enabled diversity 662 during the scan 676 (e.g., one or more scans) and/or the connection setup packet(s) 668a-n. Additionally or alternatively, the wireless communication device 102 may determine to apply disabled diversity 664 during the connection packet(s) 670a-m. For example, the wireless communication device 102 may perform inter-packet diversity switching 666 to disable diversity between the connection setup packet(s) 668a-n and the connection packet(s) 670a-m (e.g., between packet scheme A 672 and packet scheme B 674).

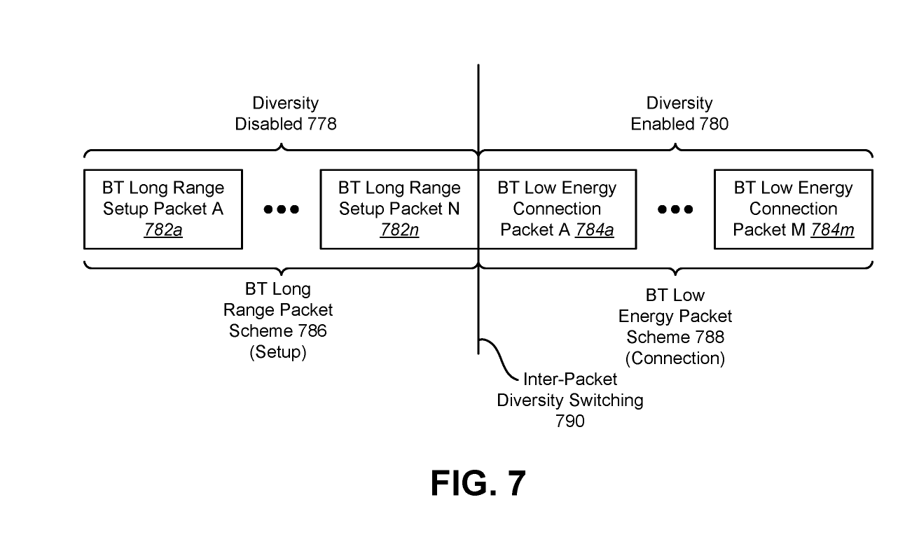

FIG. 7 illustrates yet another example of inter-packet diversity switching 790. In particular, FIG. 7 illustrates one or more BT Long Range setup packets 782a-n and one or more BT Low Energy connection packets 784a-m. In this example, the wireless communication device 102 may perform antecedent diversity setting determination to determine a connection setup packet type and a connection packet type. As illustrated in FIG. 7, the packet type determined for connection setup may correspond to the BT Long Range packet scheme 786. The packet type determined for connection may correspond to the BT Low Energy packet scheme 788.

Based on the connection setup packet type and the connection packet type, the wireless communication device 102 may determine that the BT Long Range setup packet(s) 782a-n will be more robust than the BT Low Energy connection packet(s) 784a-m. The wireless communication device 102 may determine to apply disabled diversity 778 during the BT Long Range setup packet(s) 782a-n. Additionally or alternatively, the wireless communication device 102 may determine to apply enabled diversity 780 during the BT Low Energy connection packet(s) 784a-m. For example, the wireless communication device 102 may perform inter-packet diversity switching 790 to enable diversity between the BT Long Range setup packet(s) 782a-n and the BT Low Energy connection packet(s) 784a-m.

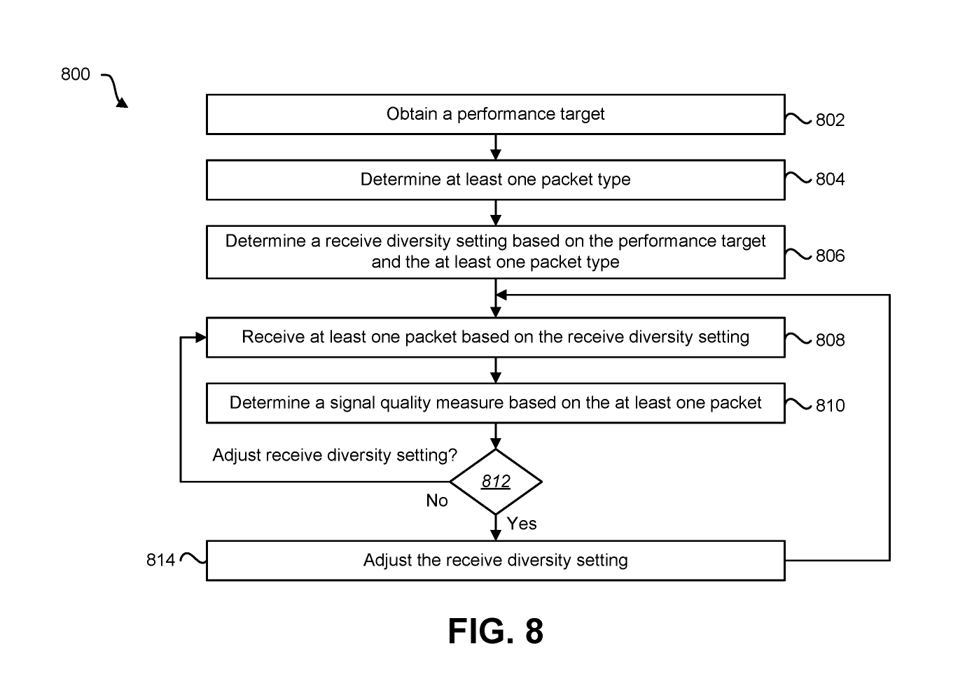

FIG. 8 is a flow diagram illustrating an example of a more specific method 800 for controlling receive diversity for WPAN communication. The method 800 may be performed by the wireless communication device 102 described in connection with FIG. 1. The wireless communication device 102 may obtain 802 a performance target. This may be accomplished as described in connection with FIG. 1. For example, the wireless communication device 102 may receive one or more inputs that indicate the performance target.

The wireless communication device 102 may determine 804 at least one packet type (for a subsequent WPAN communication, for example). This may be accomplished as described in connection with one or more of FIGS. 1-2.

The wireless communication device 102 may determine 806 a receive diversity setting based on the performance target and the at least one packet type. This may be accomplished as described in connection with FIG. 1. For example, the wireless communication device 102 may determine diversity setting(s) that meet the performance target (e.g., performance objective and/or performance threshold).

The wireless communication device 102 may receive 808 at least one packet based on the diversity setting. This may be accomplished as described in connection with one or more of FIGS. 1-7. For example, the wireless communication device 102 may control a receiver to enable and/or disable diversity in accordance with the previously determined 804 diversity setting(s) while receiving one or more packets from a remote device. For instance, the one or more packets may be received during a subsequent communication (e.g., one or more subsequent packets) based on the antecedent diversity setting determination 806.

In some configurations, the wireless communication device 102 may optionally determine 810 a signal quality measure based on the at least one packet. This may be accomplished as described in connection with FIG. 1. For example, the wireless communication device 102 may determine 810 RSSI, packet retransmission rate, error correction rate, and/or another signal quality measure.

The wireless communication device 102 may optionally determine 812 whether to adjust a receive diversity setting. This may be accomplished as described in connection with FIG. 1. For example, the wireless communication device 102 may compare the signal quality measure with a performance target (e.g., performance threshold). For instance, the wireless communication device 102 may compare the determined RSSI with a threshold RSSI and/or may compare a packet error rate with a threshold packet error rate, etc. If the signal quality measure does not meet the performance target (e.g., performance threshold), the wireless communication device 102 may determine to adjust the receive diversity setting. For example, if adjusting the receive diversity may improve performance in accordance with the performance target, the wireless communication device 102 may determine to adjust the receive diversity setting. In a case that the wireless communication device 102 determines 812 not to adjust the receive diversity setting, the wireless communication device 102 may continue to receive 808 one or more additional packets with the current receive diversity setting.

In a case that the wireless communication device 102 determines 812 to adjust the receive diversity setting, the wireless communication device 102 may optionally adjust 814 the receive diversity setting. For example, the wireless communication device 102 may enable receive diversity (if currently disabled, for instance) or may disable receive diversity (if currently enabled, for instance).

It should be noted that in some configurations, the method 800 may not include determining 810 a signal quality measure, determining 812 whether to adjust a receive diversity setting, and/or adjusting 814 the receive diversity setting. Alternatively, determining 810 a signal quality measure, determining 812 whether to adjust a receive diversity setting, and/or adjusting 814 the receive diversity setting may be performed after performing the antecedent receive diversity setting determination (which may not be based on a signal measure, for example). Alternatively, any signal measurement and/or diversity adjustment based on the signal measurement may be performed independently from the antecedent receive diversity setting determination.

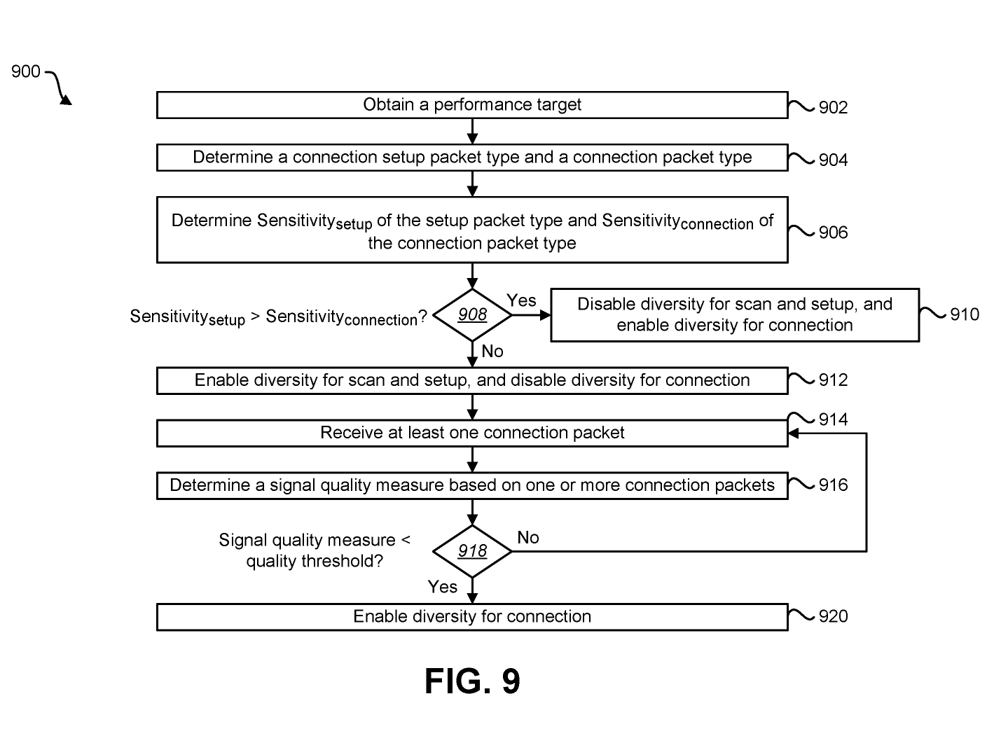

FIG. 9 is a flow diagram illustrating a more specific configuration of a method 900 for controlling receive diversity for WPAN communication. The method 900 may be performed by the wireless communication device 102 described in connection with FIG. 1. The wireless communication device 102 may obtain 902 a performance target. This may be accomplished as described in connection with one or more of FIGS. 1 and 8. For example, the wireless communication device 102 may receive one or more inputs that indicate a balance performance target.

The wireless communication device 102 may determine 904 a connection setup packet type and a connection packet type (for a subsequent WPAN communication, for example). This may be accomplished as described in connection with one or more of FIGS. 1-2 and 8.

The wireless communication device 102 may determine 906 a receiver sensitivity of the setup packet type (Sensitivityₛₑₜᵤₚ) and a receiver sensitivity of the connection packet type (Sensitivity_{connection}). This may be accomplished as described in connection with FIG. 1. For example, the wireless communication device 102 may retrieve the receive sensitivities (e.g., predetermined receive sensitivities) from memory (e.g., a memory structure, a lookup table, an array, a list, etc.). Receiver sensitivity may be expressed in decibel milliwatt units (dBm) in some implementations.

In some approaches, the wireless communication device 102 may look up Sensitivityₛₑₜᵤₚ in a lookup table of receive sensitivities based on the setup packet type. The wireless communication device 102 may also look up Sensitivity_{connection} in a lookup table of receive sensitivities based on the connection packet type. The lookup table may be a table of predetermined receiver sensitivities based on (e.g., indexed by) packet type. In some configurations, the lookup table may also include receiver sensitivities based on diversity setting (e.g., enabled diversity and disabled diversity). In some approaches, the wireless communication device 102 may look up one or more of Sensitivityₛₑₜᵤₚ and/or Sensitivity_{connection} for disabled diversity, for enabled diversity or both.

The wireless communication device 102 may determine 908 whether the setup packet receiver sensitivity (Sensitivityₛₑₜᵤₚ) is greater that the connection packet receiver sensitivity (Sensitivity_{connection}). This may be accomplished as described in connection with FIG. 1. For example, the wireless communication device 102 may determine whether Sensitivityₛₑₜᵤₚ>Sensitivity_{connection}.

In a case that the setup packet receiver sensitivity (Sensitivityₛₑₜᵤₚ) is greater that the connection packet receiver sensitivity (Sensitivity_{connection}), the wireless communication device 102 may disable 910 diversity for scan and/or setup (e.g., one or more setup packets) and/or may enable diversity for connection (e.g., one or more connection packets). For example, the wireless communication device 102 may set diversity settings to provide no diversity (e.g., a single active receive antenna) for scan and/or setup, and to provide diversity (e.g., two or more active receive antennas) for connection. The wireless communication device 102 may receive one or more packets (e.g., a subsequent communication) in accordance with the diversity settings.

In a case that the setup packet receiver sensitivity (Sensitivityₛₑₜᵤₚ) is not greater than the connection packet receiver sensitivity (Sensitivity_{connection}), the wireless communication device 102 may enable 912 diversity for scan and/or setup (e.g., one or more setup packets) and/or may disable diversity for connection (e.g., one or more connection packets). For example, the wireless communication device 102 may set diversity settings to provide diversity (e.g., two or more active receive antennas) for scan and/or setup, and to provide no diversity (e.g., a single active receive antenna) for connection.

The wireless communication device 102 may receive 914 at least one connection packet based on the diversity setting (e.g., disabled diversity). For example, the wireless communication device 102 may control a receiver to disable diversity for one or more connection packets. For instance, the one or more connection packets may be received during a subsequent communication (e.g., one or more subsequent packets) based on the antecedent diversity setting determination.

In some configurations, the wireless communication device 102 may optionally determine 916 a signal quality measure based on the one or more connection packets. This may be accomplished as described in connection with FIG. 1. For example, the wireless communication device 102 may determine 916 RSSI, packet retransmission rate, error correction rate, and/or another signal quality measure based on the one or more connection packets.

The wireless communication device 102 may optionally determine 918 whether the signal quality measure is less than a quality threshold. This may be accomplished as described in connection with FIG. 1. For example, the wireless communication device 102 may compare the signal quality measure with a performance target (e.g., performance threshold). For instance, the wireless communication device 102 may compare the determined RSSI with a threshold RSSI and/or may compare a packet error rate with a threshold packet error rate, etc. If the signal quality measure is less than the quality threshold, the wireless communication device 102 may optionally enable 920 diversity for connection (e.g., one or more subsequent connection packets). If the signal quality measure is not less than (e.g., is greater than or equal to) the quality threshold, the wireless communication device 102 may continue to receive 914 one or more connection packets with diversity disabled. This may be an example of runtime diversity setting determination, since the diversity setting is determined based on active signaling.

It should be noted that in some configurations, the method 900 may not include determining 916 a signal quality measure, determining 918 whether the signal quality measure is less than a quality threshold, and/or enabling 920 diversity for connection based on the determination 918. Alternatively, determining 918 a signal quality measure, determining 918 whether the signal quality measure is less than a quality threshold, and/or enabling 920 diversity for connection based on the determination 918 may be performed after performing the antecedent receive diversity setting determination (which may not be based on a signal measure, for example). Alternatively, any signal measurement and/or diversity adjustment based on the signal measurement may be performed independently from the antecedent receive diversity setting determination.

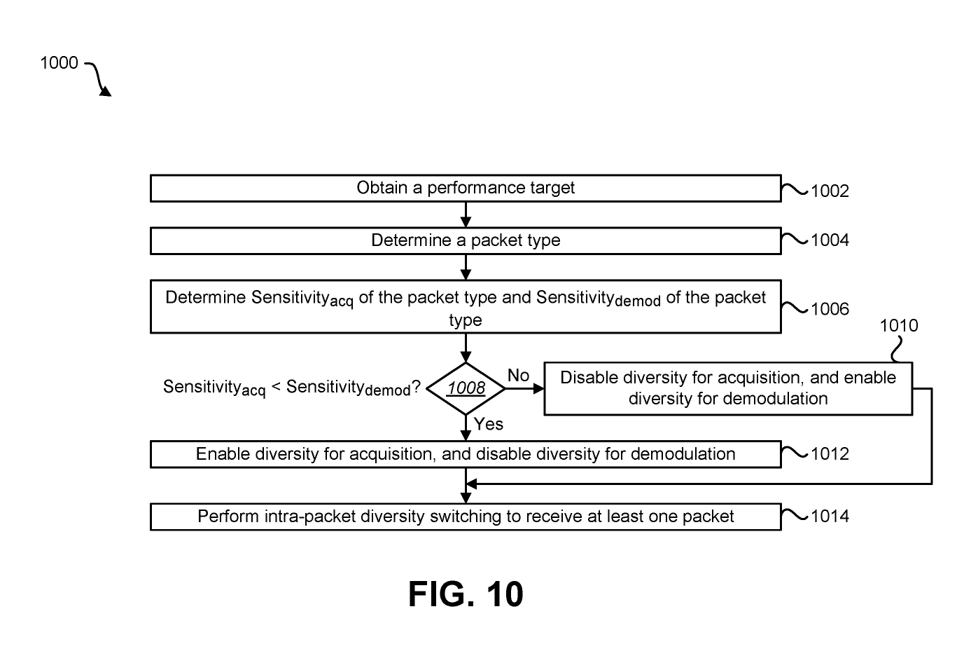

FIG. 10 is a flow diagram illustrating another more specific configuration of a method 1000 for controlling receive diversity for WPAN communication. The method 1000 may be performed by the wireless communication device 102 described in connection with FIG. 1. The wireless communication device 102 may obtain 1002 a performance target. This may be accomplished as described in connection with one or more of FIGS. 1 and 8. For example, the wireless communication device 102 may receive one or more inputs that indicate a balance performance target.

The wireless communication device 102 may determine 1004 a packet type (for a subsequent WPAN communication, for example). This may be accomplished as described in connection with one or more of FIGS. 1-2 and 8.

The wireless communication device 102 may determine 1006 a receiver sensitivity of the acquisition portion (Sensitivity_{acq}) and a receiver sensitivity of the demodulation portion (Sensitivity_{demod}) of the packet type. This may be accomplished as described in connection with FIG. 1. For example, the wireless communication device 102 may retrieve the receive sensitivities (e.g., predetermined receive sensitivities) from memory (e.g., a memory structure, a lookup table, an array, a list, etc.).

In some approaches, the wireless communication device 102 may look up Sensitivity_{acq} in a lookup table of receive sensitivities based on the packet type. The wireless communication device 102 may also look up Sensitivity_{demod} in a lookup table of receive sensitivities based on the packet type. The lookup table may be a table of predetermined receiver sensitivities based on (e.g., indexed by) packet type. In some configurations, the lookup table may also include receiver sensitivities based on diversity setting (e.g., enabled diversity and disabled diversity). In some approaches, the wireless communication device 102 may look up one or more of Sensitivity_{acq} and/or Sensitivity_{demod} for disabled diversity, for enabled diversity or both.

The wireless communication device 102 may determine 1008 whether the acquisition receiver sensitivity (Sensitivity_{acq}) is less that the demodulation receiver sensitivity (Sensitivity_{demod}). This may be accomplished as described in connection with FIG. 1. For example, the wireless communication device 102 may determine whether Sensitivity_{acq}<Sensitivity_{demod}.

In a case that the acquisition receiver sensitivity (Sensitivity_{acq}) is not less than (e.g., is greater than or equal to) the demodulation receiver sensitivity (Sensitivity_{demod}), the wireless communication device 102 may disable 1010 diversity for acquisition (e.g., the acquisition portion of one or more packets) and/or may enable diversity for demodulation (e.g., the demodulation portion of one or more packets). For example, the wireless communication device 102 may set diversity settings to provide no diversity (e.g., a single active receive antenna) for acquisition, and to provide diversity (e.g., two or more active receive antennas) for demodulation. The wireless communication device 102 may receive one or more packets (e.g., a subsequent communication) in accordance with the diversity settings. For example, the wireless communication device 102 may perform 1014 intra-packet diversity switching to receive at least one packet based on the diversity setting (e.g., disabled diversity for acquisition and enabled diversity for demodulation).

In a case that the acquisition receiver sensitivity (Sensitivity_{acq}) is less than the demodulation receiver sensitivity (Sensitivity_{demod}), the wireless communication device 102 may enable 1012 diversity for acquisition (e.g., the acquisition portion of one or more packets) and/or may disable diversity for demodulation (e.g., the demodulation portion of one or more packets). For example, the wireless communication device 102 may set diversity settings to provide diversity (e.g., two or more active receive antennas) for acquisition, and to provide no diversity (e.g., a single active receive antenna) for demodulation.

The wireless communication device 102 may receive one or more packets (e.g., a subsequent communication) in accordance with the diversity settings. For example, the wireless communication device 102 may perform 1014 intra-packet diversity switching to receive at least one packet based on the diversity setting (e.g., enabled diversity for acquisition and disabled diversity for demodulation). For instance, the one or more packets may be received during a subsequent communication (e.g., one or more subsequent packets) based on the antecedent diversity setting determination.

It should be noted that one or more aspects of multiple configurations may be combined in some implementations. For example, the wireless communication device 102 may determine diversity settings on a packet basis (e.g., FIG. 9) and on a packet portion basis (e.g., FIG. 10). For instance, the wireless communication device 102 may determine diversity settings for setup packets, connection packets and portions of each packet.

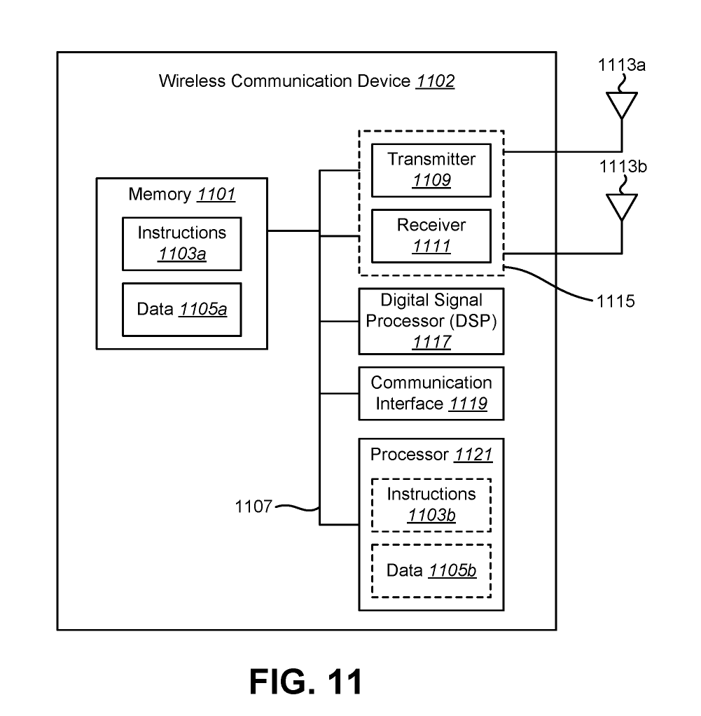

FIG. 11 illustrates certain components that may be included within a wireless communication device 1102. The wireless communication device 1102 may be a wireless device, an access terminal, a mobile station, a user equipment (UE), a laptop computer, a desktop computer, a wireless headset, etc. In some configurations, the wireless communication device 1102 may be implemented in accordance with the wireless communication device 102 described in connection with FIG. 1.

The wireless communication device 1102 includes a processor 1121. The processor 1121 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1121 may be referred to as a central processing unit (CPU). Although just a single processor 1121 is shown in the wireless communication device 1102 of FIG. 11, in an alternative configuration, a combination of processors (e.g., an ARM and DSP) could be used.

The wireless communication device 1102 also includes memory 1101 in electronic communication with the processor (e.g., the processor 1121 can read information from and/or write information to the memory 1101). The memory 1101 may be any electronic component capable of storing electronic information. The memory 1101 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1105a and instructions 1103a may be stored in the memory 1101. The instructions may include one or more programs, routines, sub-routines, functions, procedures, code, etc. The instructions may include a single computer-readable statement or many computer-readable statements. The instructions 1103a may be executable by the processor 1121 to implement one or more of the methods disclosed herein. Executing the instructions 1103a may involve the use of the data 1105a that is stored in the memory 1101. When the processor 1121 executes the instructions 1103, various portions of the instructions 1103b may be loaded onto the processor 1121, and various pieces of data 1105b may be loaded onto the processor 1121.

The wireless communication device 1102 may also include a transmitter 1109 and a receiver 1111 to allow transmission and reception of signals to and from the wireless communication device 1102 via one or more antennas 1113a-b. The transmitter 1109 and receiver 1111 may be collectively referred to as a transceiver 1115. The wireless communication device 1102 may also include (not shown) multiplier transmitters, multiplier receivers and/or multiplier transceivers.

The wireless communication device 1102 may include a digital signal processor (DSP) 1117. The wireless communication device 1102 may also include a communications interface 1119. The communications interface 1119 may provide one or more interfaces for input and/or output. In some configurations, the communication interface 1119 may allow a user to interact with the wireless communication device 1102.

The various components of the wireless communication device 1102 may be coupled together by one or more buses, which may include a power bus, a control signal bus, a status signal bus, a data bus, etc. For the sake of clarity, the various buses are illustrated in FIG. 11 as a bus system 1107.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as illustrated by FIG. 2, FIG. 8, FIG. 9 and FIG. 10, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B, and C” or the phrase “one or more of A, B, or C” should be interpreted to mean any of: only A, only B, only C, A and B (but not C), B and C (but not A), A and C (but not B), or all of A, B, and C.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method performed by a wireless communication device, comprising:
determining at least one packet type for subsequent wireless personal area network (WPAN) communication;
determining at least one receive diversity setting based on the at least one packet type; and
receiving at least one packet based on the at least one receive diversity setting.

2. The method of claim 1, further comprising obtaining a performance target, wherein determining the at least one receive diversity setting is further based on the performance target.

3. The method of claim 1, wherein determining the at least one receive diversity setting comprises:
determining a first diversity setting for an acquisition portion of the at least one packet; and
determining a different second diversity setting for a demodulation portion of the at least one packet.

4. The method of claim 3, wherein the first diversity setting is enabled diversity and the second diversity setting is disabled diversity, or the first diversity setting is disabled diversity and the second diversity setting is enabled diversity.

5. The method of claim 1, wherein receiving at least one packet based on the at least one receive diversity setting comprises performing intra-packet diversity switching.

6. The method of claim 1, wherein determining the at least one receive diversity setting comprises:
determining a first diversity setting for a first packet type, wherein the first packet type is used for setup of a connection; and
determining a different second diversity setting for a second packet type, wherein the second packet type is used for the connection.

7. The method of claim 1, wherein receiving at least one packet based on the at least one receive diversity setting comprises performing inter-packet diversity switching.

8. The method of claim 1, wherein a first packet scheme includes a first packet type for setup and a second packet type for connection, and wherein a second packet scheme includes a third packet type for setup and a fourth packet type for connection, and wherein the method further comprises using the first packet type of the first packet scheme for setup and using the fourth packet type of the second packet scheme for connection.

9. The method of claim 1, further comprising:
determining a signal quality measure based on the at least one packet; and
determining whether to adjust the at least one receive diversity setting based on the signal quality measure.

10. The method of claim 9, wherein determining whether to adjust the at least one receive diversity setting based on the signal quality measure comprises determining to enable diversity for a connection in a case that the signal quality measure is below a quality threshold.

11. A wireless communication device, comprising:
a memory;
a processor coupled to the memory, wherein the processor is configured to:
determine at least one packet type for subsequent wireless personal area network (WPAN) communication;
determine at least one receive diversity setting based on the at least one packet type; and
a receiver coupled to the processor, wherein the receiver is configured to receive at least one packet based on the at least one receive diversity setting.

12. The wireless communication device of claim 11, wherein the processor is configured to obtain a performance target, and wherein the processor is configured to determine the at least one receive diversity setting based on the performance target.

13. The wireless communication device of claim 11, wherein the processor is configured to determine the at least one receive diversity setting by:
determining a first diversity setting for an acquisition portion of the at least one packet; and
determining a different second diversity setting for a demodulation portion of the at least one packet.

14. The wireless communication device of claim 13, wherein the first diversity setting is enabled diversity and the second diversity setting is disabled diversity, or the first diversity setting is disabled diversity and the second diversity setting is enabled diversity.

15. The wireless communication device of claim 11, wherein the receiver is configured to receive at least one packet based on the at least one receive diversity setting by performing intra-packet diversity switching.

16. The wireless communication device of claim 11, wherein the processor is configured to determine the at least one receive diversity setting by:
determining a first diversity setting for a first packet type, wherein the first packet type is used for setup of a connection; and
determining a different second diversity setting for a second packet type, wherein the second packet type is used for the connection.

17. The wireless communication device of claim 11, wherein the receiver is configured to receive at least one packet based on the at least one receive diversity setting by performing inter-packet diversity switching.

18. The wireless communication device of claim 11, wherein a first packet scheme includes a first packet type for setup and a second packet type for connection, and wherein a second packet scheme includes a third packet type for setup and a fourth packet type for connection, and wherein the processor is configured to use the first packet type of the first packet scheme for setup and to use the fourth packet type of the second packet scheme for connection.

19. The wireless communication device of claim 11, wherein the processor is configured to:
determine a signal quality measure based on the at least one packet; and
determine whether to adjust the at least one receive diversity setting based on the signal quality measure.

20. The wireless communication device of claim 19, wherein the processor is configured to determine whether to adjust the at least one receive diversity setting based on the signal quality measure by determining to enable diversity for a connection in a case that the signal quality measure is below a quality threshold.

21. A non-transitory tangible computer-readable medium storing computer executable code, comprising:
code for causing a wireless communication device to determine at least one packet type for subsequent wireless personal area network (WPAN) communication;
code for causing the wireless communication device to determine at least one receive diversity setting based on the at least one packet type; and
code for causing the wireless communication device to receive at least one packet based on the at least one receive diversity setting.

22. The computer-readable medium of claim 21, further comprising code for causing the wireless communication device to obtain a performance target, wherein the code for causing the wireless communication device to determine the at least one receive diversity setting is further based on the performance target.

23. The computer-readable medium of claim 21, wherein the code for causing the wireless communication device to determine the at least one receive diversity setting comprises:
code for causing the wireless communication device to determine a first diversity setting for an acquisition portion of the at least one packet; and
code for causing the wireless communication device to determine a different second diversity setting for a demodulation portion of the at least one packet.

24. The computer-readable medium of claim 21, wherein the code for causing the wireless communication device to receive at least one packet based on the at least one receive diversity setting comprises code for causing the wireless communication device to perform intra-packet diversity switching.

25. The computer-readable medium of claim 21, wherein the code for causing the wireless communication device to receive at least one packet based on the at least one receive diversity setting comprises code for causing the wireless communication device to perform inter-packet diversity switching.

26. An apparatus, comprising:
means for determining at least one packet type for subsequent wireless personal area network (WPAN) communication;
means for determining at least one receive diversity setting based on the at least one packet type; and
means for receiving at least one packet based on the at least one receive diversity setting.

27. The apparatus of claim 26, further comprising means for obtaining a performance target, wherein the means for determining the at least one receive diversity setting is further based on the performance target.

28. The apparatus of claim 26, wherein the means for determining the at least one receive diversity setting comprises:
means for determining a first diversity setting for an acquisition portion of the at least one packet; and
means for determining a different second diversity setting for a demodulation portion of the at least one packet.

29. The apparatus of claim 26, wherein the means for receiving at least one packet based on the at least one receive diversity setting comprises means for performing intra-packet diversity switching.

30. The apparatus of claim 26, wherein the means for receiving at least one packet based on the at least one receive diversity setting comprises means for performing inter-packet diversity switching.
